(19) United States
(12) Patent Application Publication
(10) Pub. No.: US 2026/0246533 A1
(43) Pub. Date: Aug. 20, 2026

(54) Contactless Coaxial Data Link

(71) Applicant: Persimmon Technologies Corporation, Wakefield, MA (US)

(72) Inventors: Michael Valasek, Wakefield, MA (US); Martin Hosek, Salem, NH (US); Sripati Sah, Wakefield, MA (US); Jan Novotny, Wakefield, MA (US)

(21) Appl. No.: 19/542,794

(22) Filed: Feb. 18, 2026

Related U.S. Application Data
(60) Provisional application No. 63/760,677, filed on Feb. 20, 2025.

(51) Int. Cl. H04B 10/25; H04B 10/11; H04B 10/50

(52) U.S. Cl. CPC H04B 10/2589; H04B 10/11; H04B 10/501

(57) ABSTRACT

A communication apparatus for optical communication comprises: a first optical data link comprising a first transmitter and a first receiver, the first optical data link being rotatable about an axis extending longitudinally through the communication apparatus, the first transmitter being configured to transmit a first optical beam in a conical cross section shape that expands from the first transmitter; and a second optical data link comprising a second transmitter and a second receiver, the second optical data link being rotatable about the axis, the second transmitter being configured to transmit a second optical beam in a conical cross section shape that expands from the second transmitter. At least one of the first transmitter or the second transmitter are adjustably positioned about the axis to minimize at least one of a first alignment angle or a second alignment angle between the respective optical beam and the axis.

### CROSS REFERENCE TO RELATED APPLICATION

This application claims priority under 35 USC 119(e) to U.S. Provisional Application No. 63/760,677, filed February 20, 2025, which is hereby incorporated by reference in its entirety.

### BACKGROUND

### Technical Field

The exemplary and non-limiting embodiments disclosed herein relate generally to contactless data transfer and, more particularly, to data links for contactless communication in coaxially aligned joints.

### Brief Description of Prior Developments

In data transfer operations, contactless data links in apparatuses may have a first data link that revolves or moves relative to a distally-located second data link. The first data link may have a first transmitter and a first receiver, and the second data link may have a second transmitter and a second receiver.

In an aligned arrangement of such contactless data links, the data links may include components aligned along an axis of rotation with one component at least partially behind the other, similar to the configuration of a reflector telescope. For example, in a first data link in an aligned arrangement with a second data link, a first receiver may be placed in front of a first transmitter such that a beam of the physical field channel may be passed from the first transmitter around the first receiver, the first receiver partially occluding the beam and only a small portion of the beam being transmitted around the first receiver to a second receiver in a second data link.

In a splitter arrangement, a first data link having a first transmitter and a first receiver may be arranged relative to a second data link having a second transmitter and a second receiver such that a beam splitter creates a junction of perpendicular beams at an intersection of the beams from each transmitter. At the intersection, one side of the beam splitter is 45 degrees to each of the transmitted beams and 45 degrees to each of the received beams. The beam splitter either splits the receiving beam to the receiver to receive, or it allows the transmitted beam to pass through to transmit.

Such arrangements may be placed directly on semiconductor chips. In these arrangements, the solution is generally provided with an alignment of the axes of a transmitter and a receiver, but such approaches suffer from a low capability of coping with a misalignment of the elements.

### SUMMARY

The following summary is merely intended to be exemplary and is not intended to limit the scope of the claims.

In one aspect, an apparatus comprises: a first data link positioned proximate a first end of an axis and rotatable about the axis, the first data link comprising a first transmitter and a first receiver; and a second data link positioned proximate a second end of the axis and rotatable about the axis, the second data link comprising a second transmitter and a second receiver. The first transmitter is configured to send data using a first optical beam that expands in cross sectional shape to the second receiver, and wherein the second transmitter is configured to send data using a second optical beam that expands in cross sectional shape to the first receiver. At least one of the first transmitter or the second receiver are adjustably positioned about the axis to minimize a first alignment angle between the first optical beam and the axis, and at least one of the second transmitter or the first receiver are adjustably positioned about the axis to minimize a second alignment angle between the second optical beam and the axis.

In another aspect, a communication apparatus for optical communication comprises: a first optical data link comprising a first transmitter and a first receiver, the first optical data link being rotatable about an axis extending longitudinally through the communication apparatus, the first transmitter being configured to transmit a first optical beam in a conical cross section shape that expands from the first transmitter; and a second optical data link comprising a second transmitter and a second receiver, the second optical data link being rotatable about the axis, the second transmitter being configured to transmit a second optical beam in a conical cross section shape that expands from the second transmitter. At least one of the first transmitter or the second transmitter are adjustably positioned about the axis to minimize at least one of a first alignment angle or a second alignment angle between the respective optical beam and the axis.

In another aspect, a method comprises: placing a first receiver of a first optical data link in line with an axis of rotation of the first optical data link; placing a second receiver of a second optical data link in line with the axis of rotation of the first optical data link and spaced from the first optical data link; placing a first transmitter proximate to the first receiver; placing a second transmitter proximate to the second receiver; adjusting a distance between the first optical data link and the second optical data link; and transmitting a first optical beam from the first transmitter in a conical cross sectional shape to the second receiver and transmitting a second optical beam from the second transmitter in a conical cross sectional shape to the first receiver.

In another aspect, an apparatus comprises: a drive; a movable arm connected to the drive, the movable arm comprising at least one link connected at a first end thereof to the drive and rotatable about an axis extending from the drive and through the first end of the link, and at least one actuator located in the drive and configured to cause a movement of the at least one link; and at least one communication apparatus located on at least one of the drive or the movable arm, the at least one communication apparatus comprising a first optical data link comprising a first transmitter and a first receiver, the first optical data link being rotatable about an optical link axis coincident with the axis, the first transmitter being configured to transmit a first optical beam in a conical cross section shape that expands from the first transmitter; and a second optical data link comprising a second transmitter and a second receiver, the second optical data link being rotatable about the optical link axis, the second transmitter being configured to transmit a second optical beam in a conical cross section shape that expands from the second transmitter. At least one of the first transmitter or the second transmitter are adjustably positioned about the optical link axis to minimize at least one of a first alignment angle or a second alignment angle between the respective optical beam and the optical link axis. At least one of the first transmitter or the second transmitter is configured to provide an optical communication link between the first optical data link and the second optical data link to control a positioning of the movable arm.

### BRIEF DESCRIPTION OF THE DRAWINGS

The foregoing aspects and other features are explained in the following description, taken in connection with the accompanying drawings, wherein:

FIG. 1A is a schematic representation of one example embodiment of a communication apparatus for optical communication;

FIG. 1B is a schematic representation of another example embodiment of a communication apparatus for optical communication;

FIG. 1C is a schematic representation of another example embodiment of a communication apparatus for optical communication;

FIG. 1D is a schematic representation of another example embodiment of a communication apparatus for optical communication;

FIG. 1E is a schematic representation of a physical field channel of a communication apparatus;

FIG. 2 is a schematic representation of data links of a communication apparatus with controllers having processors and memories;

FIG. 3 is a flow of one example of arranging elements of the communication apparatus of a communication apparatus; and

FIG. 4 is a schematic representation of a robot incorporating the data links of the communication apparatus of a communication apparatus.

### DETAILED DESCRIPTION OF EMBODIMENTS

The example embodiments described herein may be applicable in data transfer operations and in particular optical communications applications where data is communicated without any physical connection between two separated units, or where axial and/or lateral positioning of rotating units cannot be maintained. For example, the embodiments described herein may be used in applications in which coaxial joints involve the hovering of one element relative to a second element using air cushion bearings or magnetic levitation technology or anywhere where it is not possible to precisely align embodiments or it is not desired to align. Other applications in which the example embodiments disclosed herein may be used include infinity rotation or endless rotation. Motors or units having infinity rotation or endless rotation, for example, may rotate in only one direction or be otherwise not limited by a returning number of rotations or rotation in an opposite direction. Still other applications into which the example embodiments described herein may be incorporated include, but are not limited to, rotor/stator units, power transfer devices (for example, turbines, vehicular power trains or braking systems, or the like), satellites, or robots (for example, in the movement of robot arms).

Although the apparatuses described herein are indicated as having two units rotating about an axis, it should be understood that there may be more than two units. It should also be understood that rotation may be carried out by one, two, or all of the units. It should also be understood that the units may not be rotating. In particular, in a two communication unit arrangement, both communication units may rotate about an axis, one communication unit may rotate about the axis relative to the other communication unit, one communication unit may be moved or positionally adjusted relative to the other communication unit without specifically rotating, or both communication units may be stationary.

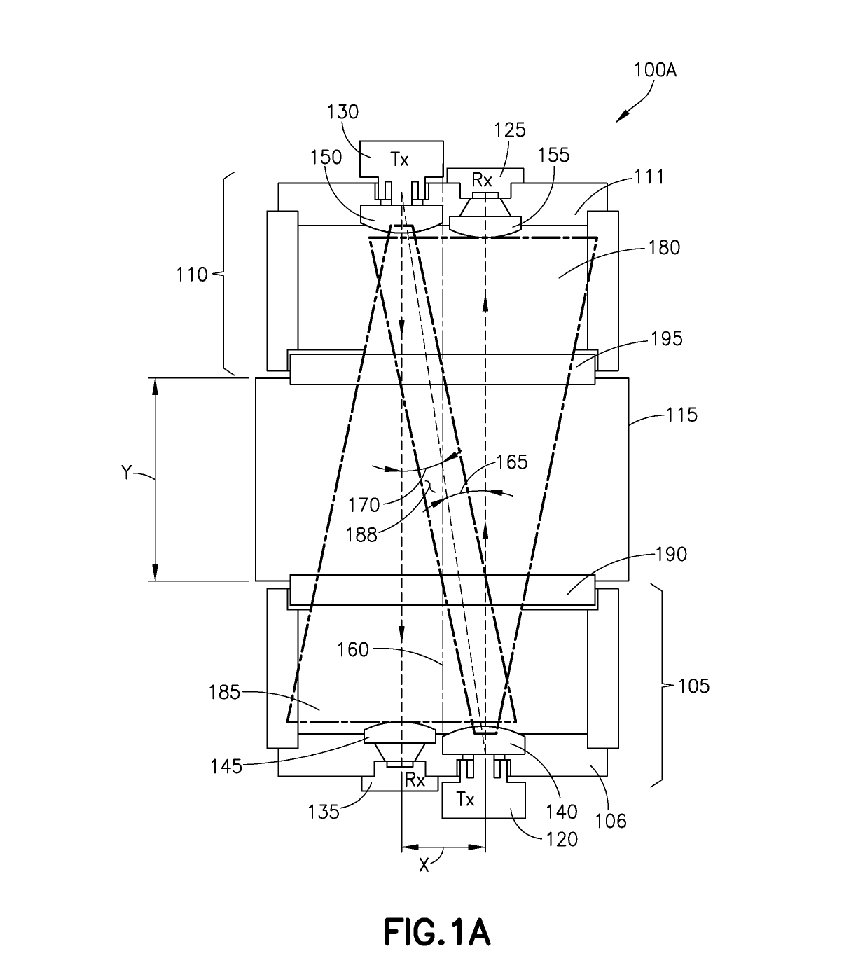

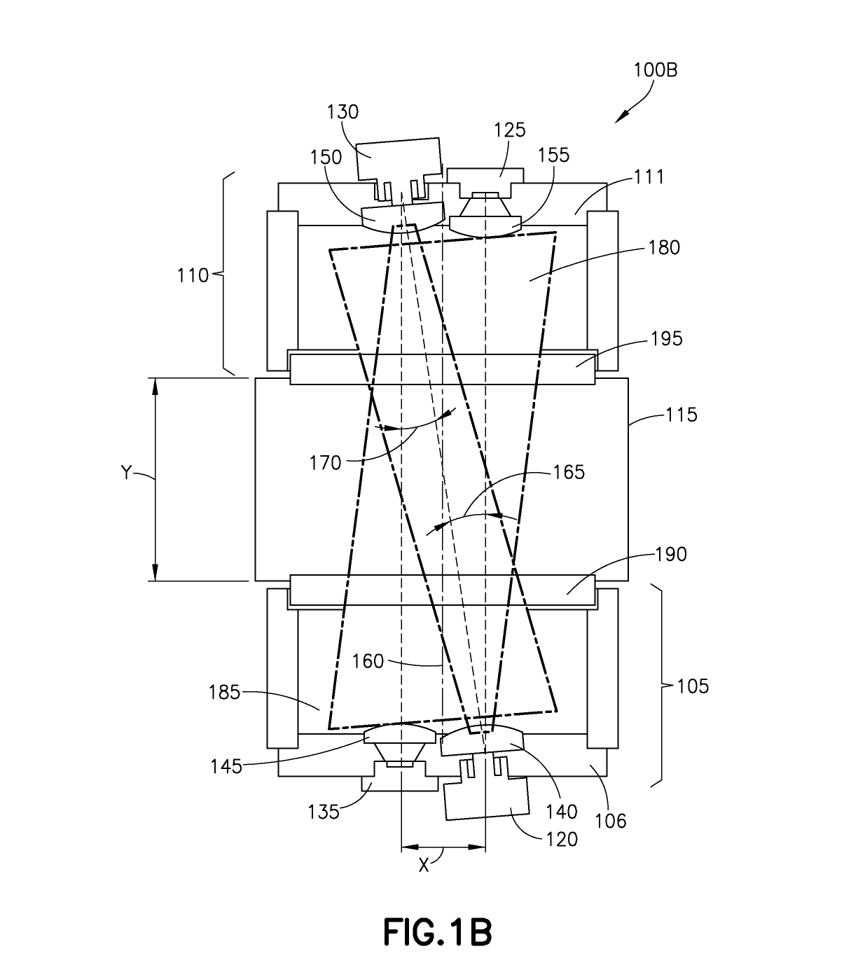

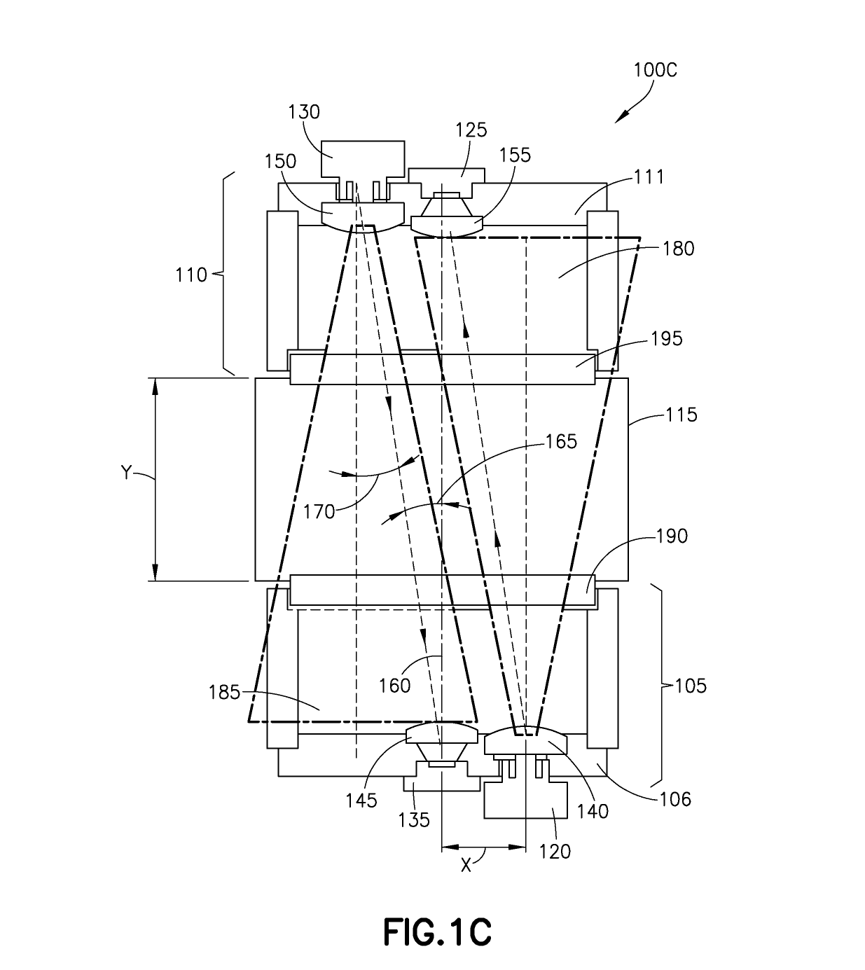

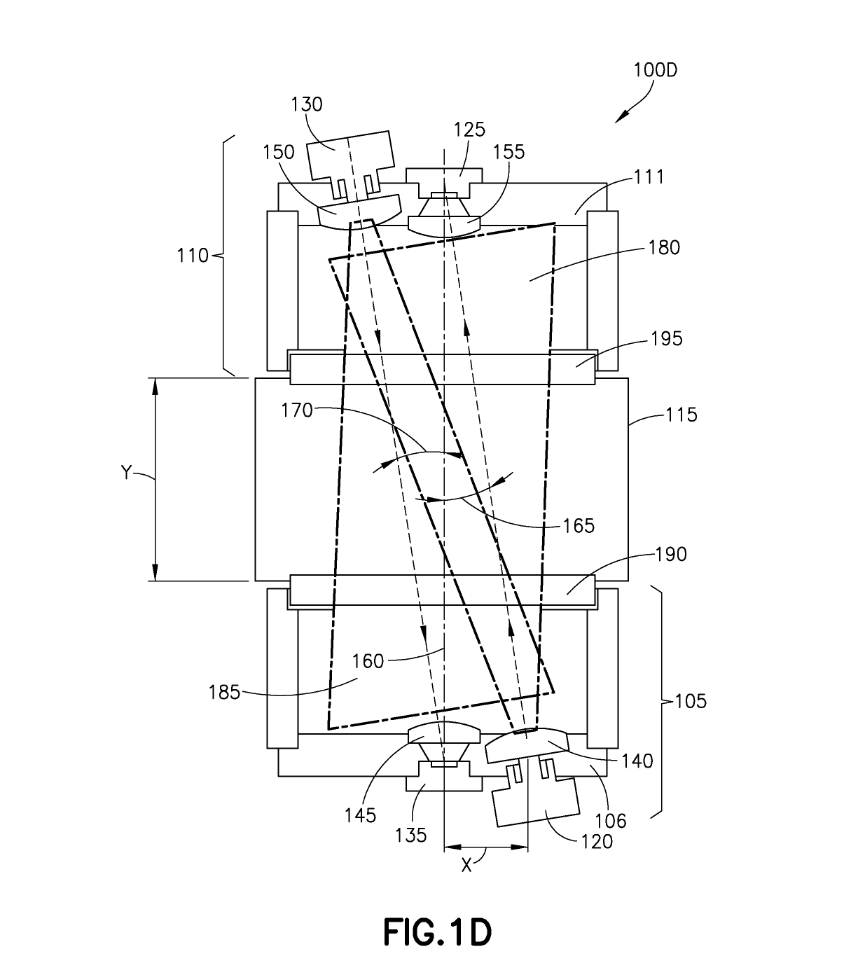

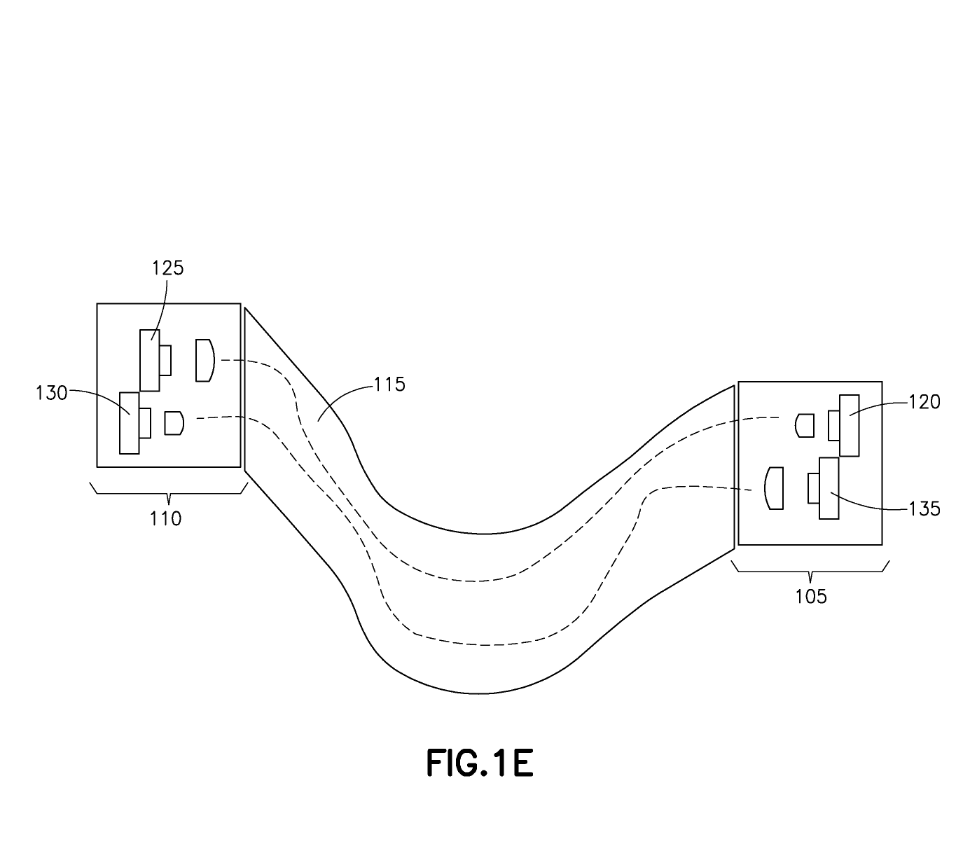

Referring to FIG. 1A, one example embodiment of a communication apparatus for optical communication is shown generally at 100A and is hereinafter referred to as “apparatus 100A.” Apparatus 100A comprises two communication half units, namely, a first communication half unit or first data link 105 and a second communication half unit or second data link 110 arranged to face each other to create communication therebetween across a physical field channel 115. The physical field channel 115 comprises a space or active area between the first and second data links 105, 110, the physical field channel 115 being modulated to send and receive data using optical beams. The first data link 105 operates as a physical layer converter to provide data input through the physical field channel 115 using a transmitter 120, with the second data link 110 operating as a corresponding physical layer converter to receive the data input from the physical field channel 115 using a receiver 125. Correspondingly, the second data link 110 also operates as a physical layer converter to provide data input through the physical field channel 115 using a transmitter 130, with the first data link 105 operating as a corresponding physical layer converter to receive the data input from the physical field channel 115 using a receiver 135. In apparatus 100A, transmissions from the transmitters 120, 130 to the receivers 125, 135 are straight with each transmission being offset from and parallel to an axis of rotation 160 extending through the physical field channel 115 and about which the first and second data links 105, 110 rotate. The transmission paths and receiving paths are equal in length.

Although each data link 105, 110 is illustrated as having one receiver 120, 130 and one transmitter 125, 135, respectively, each data link 105, 110 may accommodate two or more transmitters and two or more receivers. The transmitter(s) 120, 130 and the receiver(s) 125, 135 are discrete components and are configured to send or receive, respectively, signals such as modulated optical beams through the physical field channel 115. Physical shaping elements 140, 145 at the first data link 105 and physical shaping elements 150, 155 at the second data link 110 may be used to change the density and shape of the beam shapes (shown as 180, 185 and described below) as they pass through the physical field channel 115. In particular, the physical shaping elements 140, 145 of the first data link 105 as well as the physical shaping elements 150, 155 of the second data link 110 may increase or decrease in diameter to affect the density or shape of the beam shapes in the physical field channel 115. For example, a polarization filter or other type of filter through which the beam is passed may change the properties of the beam, thus creating useful properties of the modified beam. An optical lens, for example, may be one type of physical shaping element that may change a focal point of the beam, thereby changing properties relating to density and focal point. The physical shaping elements 140, 145 of the first data link 105 and the physical shaping elements 150, 155 of the second data link 110 described herein may be, for example, plano-convex lenses or flat transmissive glasses.

Still referring to FIG. 1A, the first data link 105 and the second data link 110 may be coaxially arranged in order to compensate for a non-coaxial arrangement of the placement of the components. The transmitter 120, receiver 135, and physical shaping elements 140, 145 of the first data link 105 may be arranged close to the axis of rotation 160 extending through the physical field channel 115. The transmitter 120, receiver 135, and physical shaping elements 140, 145 are physically dimensioned to be suitably arranged within the first data link 105. Likewise, the transmitter 130, receiver 125, and physical shaping elements 150, 155 of the second data link 110 may also be arranged close to the axis of rotation 160. The transmitter 130, receiver 125, and physical shaping elements 150, 155 are physically dimensioned to be suitably arranged within the second data link 110. The arrangement of the transmitter 120 and the receiver 125 close to the axis of rotation allows for the minimization of an alignment angle 165 between the aligned transmitter 120 and the receiver 125 and the axis of rotation 160. Also, the arrangement of the transmitter 130 and the receiver 135 close to the axis of rotation 160 allows for the minimization of an alignment angle 170 between the aligned transmitter 130 and the receiver 135 close to the axis of rotation 160. The transmitter 120 and the adjacently-positioned receiver 135 may be built on, for example, a semiconductor die 106 on a substrate forming the first data link 105, and the transmitter 130 and the adjacently-positioned receiver 125 may be built on, for example, another semiconductor die 111 on a substrate forming the second data link 110. The physical shaping elements 140, 145 may be suitably arranged with respect to the transmitter 120 and the receiver 135, and the physical shaping elements 150, 155 may also be suitably arranged with respect to the transmitter 130 and the receiver 125. A distance x between each transmitter and its adjacently-positioned receiver may be negligible in comparison to an overall distance y between the first data link 105 and the second data link 110. In some embodiments, the distance x may be a half unit separation in tens of units of the distance y.

The alignment angles 165, 170 with a maximum alignment tolerance to misalignment are in range of a field of acceptance of each receiver 125, 135 in order to obtain desired functionality. The transmitters 120, 130 and the receivers 125, 135 may each have axes that are parallel to the axes of other transmitters or receivers. The alignment angle 165, which is created by an axis extending between the transmitter 120 and the receiver 125 with the axis of rotation 160, may be calculated from the distance y of separation of the first data link 105 and the second data link 110 as well as the distances x between the transmitters 120, 130 and receivers 125, 135 within each communication link 105, 110. The alignment angle 170 may be similarly calculated. Although the distances x and y are shown as being taken between the data links 105, 110 and the transmitters and receivers, the distances x and y may be taken between the physical shaping elements within each data link. The physical field channel 115 may operate to extend the range of the field of acceptance over one or both the x and y distances.

A first beam shape 180 is defined in the space between the transmitter 120 of the first data link 105 and the receiver 125 of the second data link 110. A second beam shape 185 is also defined in the space between the transmitter 130 of the second data link 110 and the receiver 135 of the first data link 105. An overlap of the first beam shape 180 and the second beam shape 185 is shown as a rhomboid shape at 188 and extending from the physical shaping element 150 to the physical shaping element 140. With regard to the first beam shape 180, properties such as divergence and power distribution are design outcomes from the properties of the transmitters 120, 130, the number of transmitters 120, 130 used, the shaping elements 140, 145, 150, 155 (if used), and the desired functionality of the apparatus 100A based on the misalignment. The first beam shape 180 maintains the receiver 125 exposed to the physical field channel 115, which accordingly maintains a continuous link between the first data link 105 and the second data link 110 without interruption. The second beam shape 185 also maintains the receiver 135 exposed to the physical field channel 115, which further maintains the continuous link between the first data link 105 and the second data link 110 without interruption. Positioning of transmitters and receivers may vary based on an expected misalignment and properties of the transmitters 120, 130 and the receivers 125, 135. In apparatus 100A, the first beam shape 180 is received at the second data link 110 such that a trace of the transmitted beam is circular, and the second beam shape 185 is received at the first data link 105 such that a trace of the transmitted beam is circular.

Referring to FIG. 1B, another example embodiment of a communication apparatus for optical communication is shown generally at 100B and is hereinafter referred to as “apparatus 100B.” Apparatus 100B comprises two communication half units, namely, a first communication half unit or first data link 105 and a second communication half unit or second data link 110 arranged to face each other to create communication therebetween across a physical field channel 115, similar to apparatus 100A. In apparatus 100B, the first data link 105 is coaxial with the second data link 110, but the axes of the transmitters may be tilted relative to their adjacently-positioned receivers to achieve desired functionality. For example, as shown, the transmitter 120 is aligned with the receiver 125, and the transmitter 130 is aligned with the receiver 135, both alignments being parallel to the axis of rotation 160, but the transmitters 120, 130 are angled relative to the receivers 125, 135 such that the receiving at the respective receiver is off-center from the transmission. In particular, in apparatus 100B, the first beam shape 180 is received at the second data link 110 such that a trace of the transmitted beam is elliptical and the receiver 125 is not centered on the trace and is slightly off-center, and the second beam shape 185 is received at the first data link 105 such that a trace of the transmitted beam is elliptical and the receiver 135 is not centered on the trace and is slightly off-center.

Referring to FIG. 1C, another example embodiment of a communication apparatus for optical communication is shown generally at 100C and is hereinafter referred to as “apparatus 100C.” Apparatus 100C comprises two communication half units, namely, a first communication half unit or first data link 105 and a second communication half unit or second data link 110 arranged to face each other to create communication therebetween across a physical field channel 115, similar to previous embodiments. In apparatus 100C, the first data link 105 is coaxial with the second data link 110 such that the receiver 125 is coaxially aligned with the receiver 135 along the axis of rotation 160, and transmissions from the transmitters 120, 130 to the receivers 125, 145 are straight with each transmission being offset from and parallel to the axis of rotation 160 with the transmission paths and receiving paths being equal in length. In doing so, the receiving at the respective receiver is off-center from the transmission. In particular, in apparatus 100C, the first beam shape 180 is received at the second data link 110 such that a trace of the transmitted beam is circular and the receiver 125 is positioned proximate an edge of the circular trace of the first beam shape 180. Similarly, the second beam shape 185 is received at the first data link 105 such that a trace of the transmitted beam is circular and the receiver 135 is positioned proximate an edge of the circular trace of the second beam shape 185.

Referring now to FIG. 1D, another example embodiment of a communication apparatus for optical communication is shown generally at 100D and is hereinafter referred to as “apparatus 100D.” Apparatus 100D comprises two communication half units, namely, a first communication half unit or first data link 105 and a second communication half unit or second data link 110 arranged to face each other to create communication therebetween across a physical field channel 115, similar to previous embodiments. In apparatus 100D, the first data link 105 is coaxial with the second data link such that the receiver 125 is coaxially-aligned with the receiver 135 and coincident with the axis of rotation 160, but the transmitters 120, 130 are tilted to achieve desired functionality. For example, as shown, the transmitter 120 is aligned with the receiver 125, and the transmitter 130 is aligned with the receiver 135, both alignments being angled relative to the axis of rotation 160, but the transmitters 120, 130 are angled relative to the receivers 125, 135 such that the receiving at the respective receiver is off-center from the transmission. In particular, in apparatus 100D, the first beam shape 180 is received at the second data link 110 such that a trace of the transmitted beam is elliptical and the receiver 125 is substantially centered on the trace, and the second beam shape 185 is received at the first data link 105 such that a trace of the transmitted beam is elliptical and the receiver 125 is substantially centered on the trace.

Referring now to FIG. 1E, one embodiment of a physical field channel 115 for use with any of the herein disclosed communication apparatuses is shown. In any embodiment, the physical field channel 115 may not be in a straight line between the first data link 105 and the second data link 110, but may instead vary in width and direction to follow a path having one or more curves. In such an embodiment, the curved path(s) of the physical field channel 115 may comprise mirrors, reflective tubing, tubing with reflective wall elements, optical fiber, prism, ferrite, similar materials, or combinations of any of the foregoing materials to provide a desired physical field channel 115.

In any of the apparatuses 100A, 100B, 100C, or 100D, a first barrier window 190 of the first data link 105 in or at an edge of the physical field channel 115, in conjunction with a second barrier window 195 of the second data link 110 in or at an edge of the physical field channel 115, may be used to seal inner environments of the first and second data links 105, 110. This may be desirable if the separation environment is not compatible with components used within the first data link 105 and/or the second data link 110.

In any of the embodiments described herein, a transmitted beam as the first beam shape 180 is shown emanating from the transmitter 120 and being received at the receiver 125 of the second data link 110. One or more mechanisms may allow for six-axis movement of the first data link 105 to facilitate tuning of the receiving of the transmitted beam at the corresponding receiver and/or the transmitting of the transmitted beam from a corresponding transmitter. The second data link 110 may be similarly configured. Additionally, any combination of first data link 105 as described herein may be used with any other of the second data links 110 to provide a variation of upper and lower half links with mixed component arrangements.

Also, in any of the embodiments described herein, the receiver 135 and the receiver 125 may each be located at nominal positions relative to the axis of rotation 160. The transmitter 120 and the transmitter 130 are generally fixed into their respective dies 106, 111, although in some embodiments the transmitters 120, 130 may be movable in the dies 106, 111. For example, positions of one or more of the transmitters or of the one or more receivers may be adjustable using one or more actuators.

Additionally, in any of the embodiments described herein, the first beam shape 180 and the second beam shape 185 each extend through the physical field channel 115, which may be glass, prism, light pipes, or reflective tubing in order to channel the beam between the data links 105, 110. In optical arrangements, the use of such materials, piping, or tubing may be useful in the mitigation of blind spots between the data links 105, 110. In some configurations, the physical field channel 115 may be ferrite or the like.

In any of the embodiments described herein, the transmitted beam emanating from the transmitter 120 of the first data link 105 and forming the first beam shape 180 may be substantially conical in cross section and directed at the second data link 110. A transmitted beam emanating from the transmitter 130 of the second data link 110 and forming the second beam shape 185 may also be substantially conical in cross section and directed at the first data link 105. The trace of each of the first beam shape 180 and the second beam shape 185 (area illuminated by source) may be cylindrical, elliptical, or toroidal in shape (or any other shape depending upon the source properties) on the receiving surface depending upon the angle of the transmitted beam relative to the received beam.

The substantially conical cross section shape of the first beam shape 180 at least in part defines the properties of the transferred data between the first data link 105 and the second data link 110. The receiver 130 may be anywhere within the area onto which the first beam shape 180 is transmitted (for example, at the center of the trace as in FIG. 1A, slightly off from the center of the trace as in FIGS. 1B and 1D, or at the edge of the trace as in FIG. 1C.) Properties of the first beam shape 180 may be modified by operating actuators associated with the positioning of the transmitters and receivers. Properties of the first beam shape 180 may also be affected by control and changes to power of the first beam shape 180. The second beam shape 185 may be similar to the first beam shape 180.

In practical examples of any of the embodiments described herein, the apparatus (for example, apparatus 100A, 100B, 100C, or 100D) may be a standalone modular unit that is configured to be inserted, attached to, incorporated into, or used with another apparatus having rotating parts (for example, stator/rotor units, robots, or the like). In such a modular apparatus, the first data link 105 may be separated from the second data link 110 by a distance of about 70 millimeters (mm), a maximum value for the bore diameter being less than or equal to about 16 mm, and a tolerance of distance separation between the first data link 105 and the second data link 110 (for example, the distance deviation of the transmitters and receivers among variants in a robot or robotics application not during operation) being +/- about 5 mm. The total angular misalignment (with regard to a system capable of compensation assembly misalignment when one of the transmitter or receiver is fixed and the other of the transmitter or receiver is moving) may be +/- about 2 degrees. A total radial misalignment (misalignment between two axes when one of the transmitter or receiver is fixed and the other of the transmitter or receiver is moving) may be less than or equal to about 2.0 mm. In such an embodiment, the infinity axial rotation is 360 degrees.

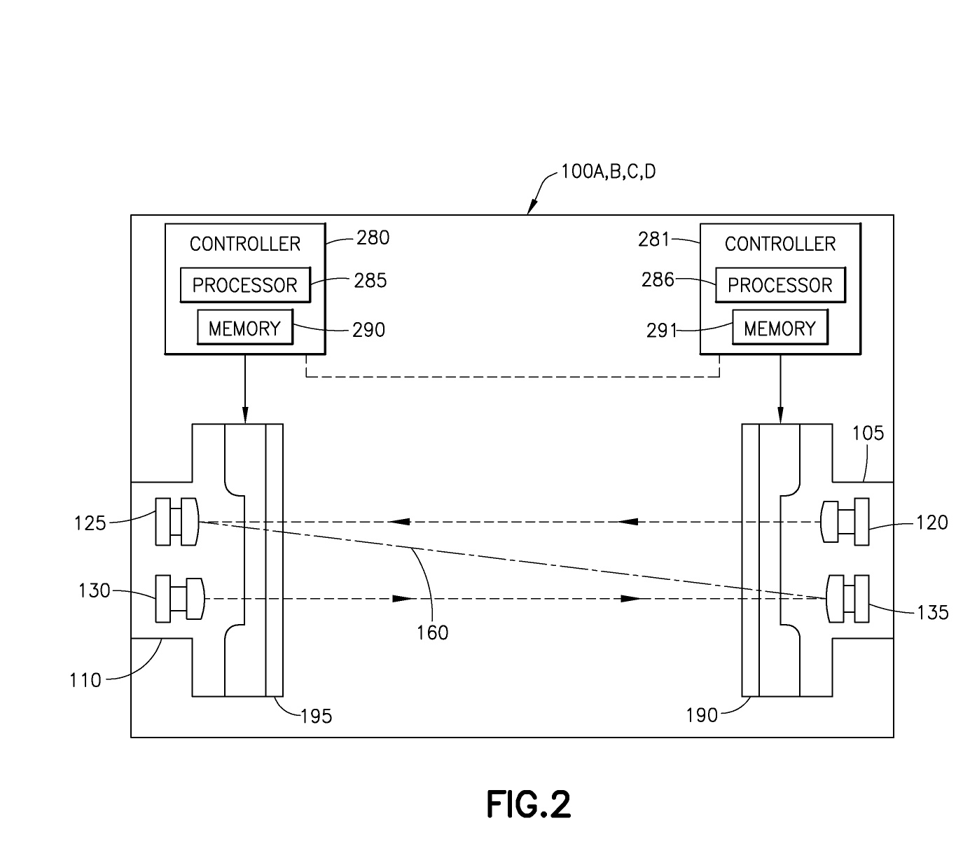

Referring to FIG. 2, the first data link 105 and/or the second data link 110 of any of the above-described apparatuses 100A, 100B, 100C, 100D may be in communication with one or more controllers 280, 281 each controller 280 having one or more processors 285, 286 and one or more non-transitory memories 290, 291 storing instructions that, when executed with the one or more processors 285, 286 cause the apparatus to perform operations defined herein. One processor 285 having memory 290 may be used to control both the first data link 105, and another processor 286 having memory 291 may be used to control the second data link 110, as shown. In the alternative, or additionally, each of the first data link 105 or the second data link 110 may be linked together, as shown by a dashed line. The one or more processors and the one or more memories may be internal to the apparatus, or they may be externally located relative to the apparatus. The controllers 280, 281 may be in wired communication with the processors and memories, as well as the first data link 105 and the second data link 110, or the controllers 280, 281 and any control of the apparatus may be wireless.

In any embodiment, each data link 105, 110 may form or be linked to a portion of a robot or located on a semiconductor chip or any other electronic device used with a robot.

In one example method of operation, a rotational/static operation of the apparatus 100 is based on a built-in ability of each of the first data link 105 and the second data link 110 to operate with a certain degree of misalignment. The degree of misalignment is a design feature of the apparatuses described herein. In such embodiments, the positions and properties of each half unit 105, 110 is less sensitive to being aligned (or slightly out of alignment) because the position and properties are by design built in misaligned positions due to the semi-coaxial arrangement.

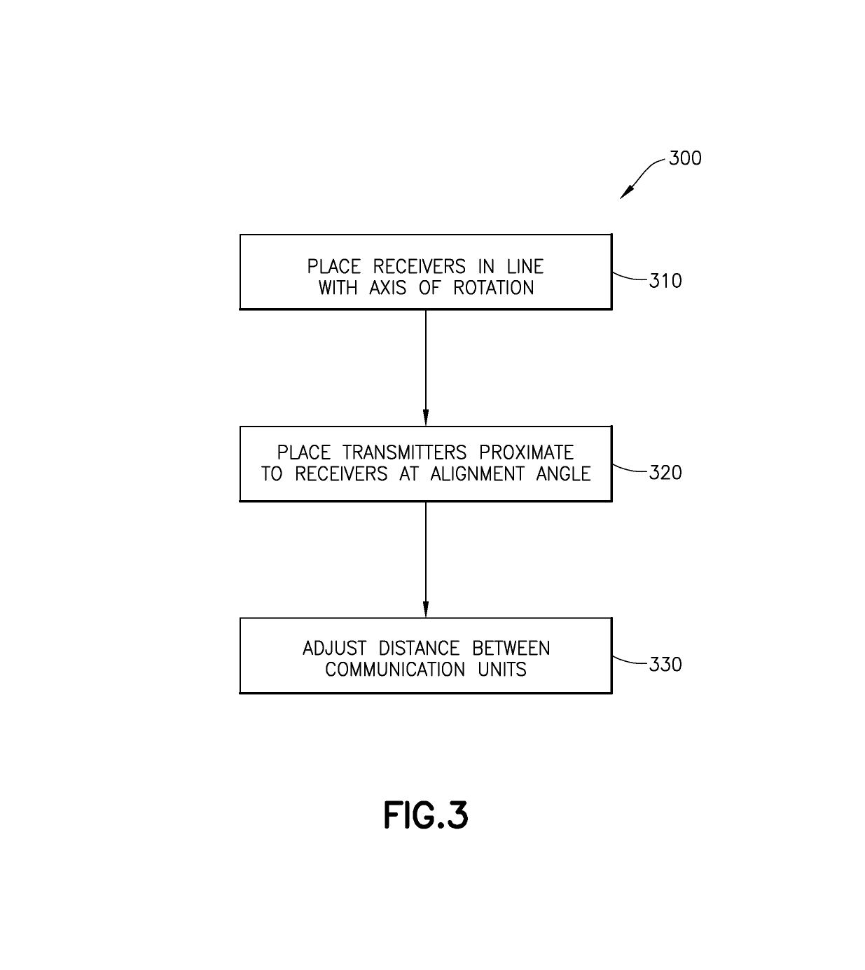

Referring now to FIG. 3, a flow of one example method of assembling the apparatus 100 having the first data link 105 and the second data link 110 is shown at 300 and is hereinafter referred to as “method 300.” In operation of the apparatus 100A, 100B, 100C, or 100D, the angle of acceptance of the beam into the receiver 125 (for example, into an aperture in the receiver 125) may be such that the physical field channel 115 is received even under conditions where the angles are non-coincident to the axis of rotation 160 through the active area.

In method 300, the transmitters 120, 130 and the receivers 125, 135 may be placed anywhere around the axis of rotation 160. However, as indicated at block 310, the receivers 125, 135 are placed in line with the axis of rotation 160. One advantage of a receiver 125, 135 aligned with the axis of rotation 160 may be useful in situations in which the beam density varies and if the receiver 125, 135 is unable to operate with a changing intensity of the first beam shape 180 or the second beam shape 185. As indicated at block 320, the transmitters 120, 130 are placed proximate to the receivers 125, 135 to align with the target receiver 125, 135 at the alignment angle 165 (or 170). As indicated at block 330, the distances between the transmitters 120, 130 and the corresponding target receivers 125, 135 is adjusted to tune a quality of optical communication between the first data link 105 and the second data link 110.

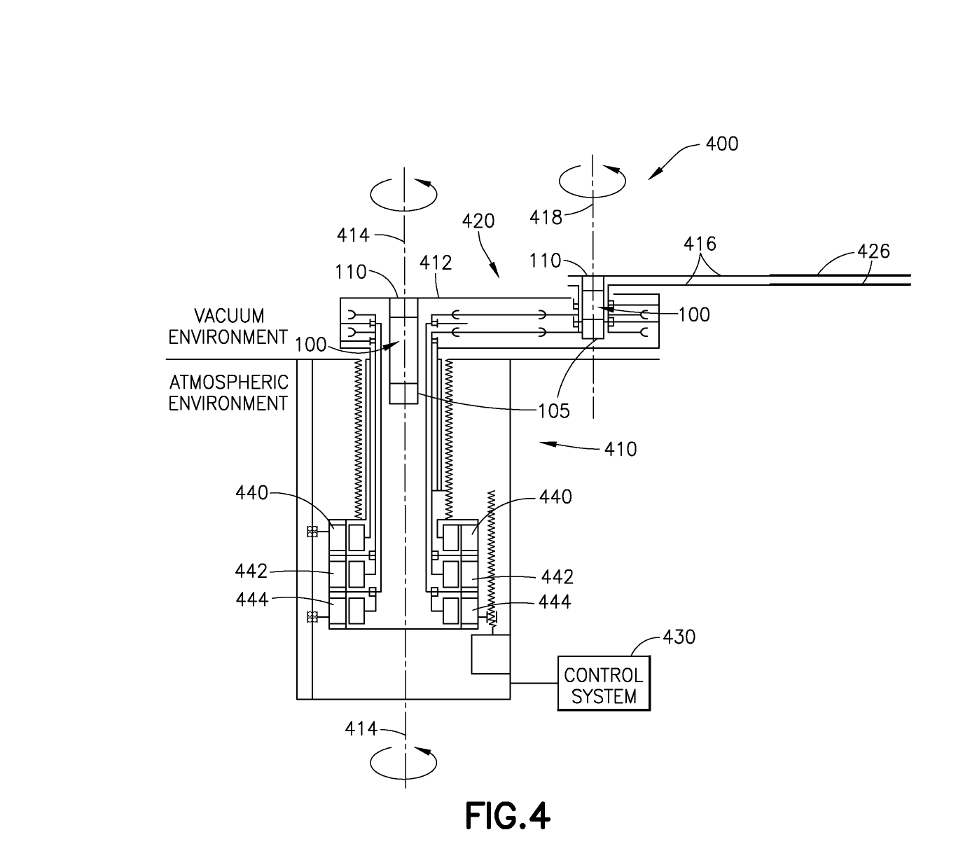

Referring to FIG. 4, one example embodiment of a robot application with which the apparatus 100A, 100B, 100C, or 100D may be used is shown. The robot application includes a robot 400 having a robot drive 410 and at least one robot arm 420 attached to the robot drive 410 and rotatable about the robot drive 410. The robot arm 420 includes, for example, a link 412 rotatable about the robot drive 410 at a drive axis 414 extending through a first end of the robot arm 420. The robot arm 420 also includes at least one end effector 416 rotatable about another axis 418 extending through a joint at a second end of the robot arm 420. The end effector(s) 416 may be configured to deliver wafers 426 or other substrates for desired processing in chambers of a semiconductor processing apparatus. Actuators 440, 442, 444 are located in the robot drive 410 to cause movements of the link 412 and the end effector(s) 416 on the robot arm 420. A control system 430 may be used to control operation of the actuators 440, 442, 444. Although the actuators 440, 442, 444 are shown being located in the drive 410, they may, in other embodiments, be distributed throughout the architecture of the robot arm 420.

In the robot 400, the apparatus 100A, 100B, 100C, or 100D may form an optical communication link with the first data link 105 located in the robot drive 410 and the second data link 110 located in the robot arm 420. In such an embodiment, the transmitter 120 located in the robot drive 420 transmits a beam as the first beam shape 180 to the receiver 125 in the robot arm 420, thereby facilitating optical communication between the robot drive 410 and the robot arm 420 during movement of the robot arm 420 about the drive axis 414. The transmitter 130 in the second data link 110 may or may not transmit a beam as the second beam shape 185 back to the receiver 135 in the first data link 105. A second apparatus 100A, 100B, 100C, or 100D may be located proximate the second end of the robot arm 420 with a second transmitter 120 transmitting a beam to a second receiver 125 in the end effector 416. Any number of apparatuses may be incorporated into the robot 400 to provide optical communication between the moving portions of the robot arm 420, thereby providing for a precise movement of the robot 400 for precise placement of wafers 426 for processing.

The apparatuses as described herein may be incorporated into the robot 400 at the axes 414, 418 extending through the joints about which the robot arm 420 and the end effector(s) 416 rotate. The receivers 125, 135 may be positioned in line with each axis 414, 418 with the transmitters 120, 130 offset from the axes 414, 418.

The example embodiments as described herein provide solutions in optical communication links that remove typical requirements for precise alignment. The example embodiments also provide abilities for optical communications to operate with barrier windows without deterioration of functionality. Furthermore, infinity rotation operates with the same functionality as do static joints, which facilitates the operability in dynamic systems. Additionally, distances between each data link 105, 110 may be adjustable or tunable according to the distances required by the physical field channel 115. Furthermore, the embodiments described herein are not limited to the use of optical elements for communication of data, however, as transmitters and receivers may be configured to transmit and receive electromagnetic fields.

In one example, operation of the apparatus achieved functionality without any loss of data while one or more of the components is moved +/- 360 degrees around the axis of rotation 160. In this example, there were: +/- 3 millimeters (mm) lateral misalignment between the first data link 105 and the second data link 110; +/- 3 degrees of angular misalignment between the data links 105, 110; +/- 10 mm distance of separation variation between data links 105, 110; A data rate of 125 Megabits per second (Mbps) at full duplex; The same modulated light wavelength on both data links 105, 110; Two separation barrier windows 155 to demonstrate protection in different environment condition between data links 105, 110; and A bit error rate tester data patterns: pathological “0,” pathological “1,” PRBS31, different packet sizes, and different data rates.

In one embodiment, an apparatus comprises: a first data link positioned proximate a first end of an axis and rotatable about the axis, the first data link comprising a first transmitter and a first receiver; and a second data link positioned proximate a second end of the axis and rotatable about the axis, the second data link comprising a second transmitter and a second receiver. The first transmitter is configured to send data using a first optical beam that expands in cross sectional shape to the second receiver, and wherein the second transmitter is configured to send data using a second optical beam that expands in cross sectional shape to the first receiver. At least one of the first transmitter or the second receiver are adjustably positioned about the axis to minimize a first alignment angle between the first optical beam and the axis, and at least one of the second transmitter or the first receiver are adjustably positioned about the axis to minimize a second alignment angle between the second optical beam and the axis.

The apparatus may comprise at least one first shaping element positioned at the first transmitter and at least one second shaping element positioned at the second receiver, the at least one first shaping element and the at least one second shaping element being configured to physically shape the first optical beam. The apparatus may further comprise at least one third shaping element positioned at the second transmitter and at least one fourth shaping element positioned at the first receiver, the at least one third shaping element and the at least one fourth shaping element being configured to physically shape the second optical beam. The first optical beam and the second optical beam define an area between the first data link and the second data link in which the first optical beam and the second optical beam are modulated. The apparatus may further comprise a first barrier window and a second barrier window, the first barrier window and the second barrier window being positioned between the first data link and the second data link. A first transmission from the first transmitter to the second receiver may be parallel to a second transmission from the second transmitter to the first receiver, the first transmission and the second transmission may be parallel to and offset from the axis, the first transmission may be received at the second receiver in a first circular trace, and the second transmission may be received at the first receiver in a second circular trace. The first transmitter may be angled relative to the second receiver such that a first transmission from the first transmitter is received at the second receiver in a first elliptical trace and offset from a center of the first elliptical trace, and the second transmitter may be angled relative to the first receiver such that a second transmission from the second transmitter is received at the first receiver in a second elliptical trace and offset from a center of the second elliptical trace. The first receiver may be coaxially aligned with the second receiver along the axis, a first transmission from the first transmitter to the second receiver may be parallel to a second transmission from the second transmitter to the first receiver, and the first transmission and the second transmission may be parallel to and offset from the axis. The first receiver may be coaxially aligned with the second receiver along the axis, the first transmitter may be angled relative to the second receiver such that a first transmission from the first transmitter is received at the second receiver in a first elliptical trace with the second receiver substantially at a center of the first elliptical trace, and the second transmitter may be angled relative to the first receiver such that a second transmission from the second transmitter is received at the first receiver in a second elliptical trace with the first receiver substantially at a center of the second elliptical trace.

In another embodiment, a communication apparatus for optical communication comprises: a first optical data link comprising a first transmitter and a first receiver, the first optical data link being rotatable about an axis extending longitudinally through the communication apparatus, the first transmitter being configured to transmit a first optical beam in a conical cross section shape that expands from the first transmitter; and a second optical data link comprising a second transmitter and a second receiver, the second optical data link being rotatable about the axis, the second transmitter being configured to transmit a second optical beam in a conical cross section shape that expands from the second transmitter. At least one of the first transmitter or the second transmitter are adjustably positioned about the axis to minimize at least one of a first alignment angle or a second alignment angle between the respective optical beam and the axis.

The first transmitter may be configured to transmit the first optical beam to the second receiver, and the second transmitter may be configured to transmit the second optical beam to the first receiver. An area between the first optical data link and the second optical data link may comprise an active area in which the first optical beam and the second optical beam are modulated. The communication apparatus may further comprise a first barrier window and a second barrier window positioned between the first optical data link and the second optical data link. The communication apparatus may further comprise a first transmitting lens on the first transmitter, a first receiving lens on the first receiver, a second transmitting lens on the second transmitter, and a second receiving lens on the second receiver. At least one of the first transmitting lens, the second transmitting lens, the first receiving lens, or the second receiving lens may be a plano-convex lens or a flat transmissive glass. The communication apparatus may further comprise a controller configured to control operations of at least one of the first optical data link or the second optical data link, the controller comprising at least at least one processor and at least one memory storing instructions that, when executed with the at least one processor, cause the communication apparatus to perform operations. The communication apparatus may further comprise at least one mechanism configured to allow for movement of at least one of the first transmitter, the second transmitter, the first receiver, or the second receiver. A first transmission from the first transmitter to the second receiver may be parallel to a second transmission from the second transmitter to the first receiver, the first transmission and the second transmission may be parallel to and offset from the axis, a first trace of the first transmission at the second receiver may be circular, and a second trace of the second transmission to the first receiver may be circular. The first transmitter may be angled relative to the second receiver such that a first transmission from the first transmitter is received at the second receiver in a first elliptical trace and offset from a center of the first elliptical trace, and the second transmitter may be angled relative to the first receiver such that a second transmission from the second transmitter is received at the first receiver in a second elliptical trace and offset from a center of the second elliptical trace. The first receiver may be coaxially aligned with the second receiver along the axis, a first transmission from the first transmitter to the second receiver may be parallel to a second transmission from the second transmitter to the first receiver, and the first transmission and the second transmission may be parallel to and offset from the axis. The first receiver may be coaxially aligned with the second receiver along the axis, the first transmitter may be angled relative to the second receiver such that a first transmission from the first transmitter is received at the second receiver in a first elliptical trace with the second receiver substantially at a center of the first elliptical trace, and the second transmitter may be angled relative to the first receiver such that a second transmission from the second transmitter is received at the first receiver in a second elliptical trace with the first receiver substantially at a center of the second elliptical trace.

In another embodiment, a method comprises: placing a first receiver of a first optical data link in line with an axis of rotation of the first optical data link; placing a second receiver of a second optical data link in line with the axis of rotation of the first optical data link and spaced from the first optical data link; placing a first transmitter proximate to the first receiver; placing a second transmitter proximate to the second receiver; adjusting a distance between the first optical data link and the second optical data link; and transmitting a first optical beam from the first transmitter in a conical cross sectional shape to the second receiver and transmitting a second optical beam from the second transmitter in a conical cross sectional shape to the first receiver.

The method may further comprise adjusting a position of the second transmitter to adjust a first alignment angle between the second transmitter and the first receiver and adjusting a position of the first transmitter to adjust a second alignment angle between the first transmitter and the second receiver, the adjusting of the alignment angles being to adjust an optical communication between the first optical data link and the second optical data link.

In another embodiment, an apparatus comprises: a drive; a movable arm connected to the drive, the movable arm comprising at least one link connected at a first end thereof to the drive and rotatable about an axis extending from the drive and through the first end of the link, and at least one actuator located in the drive and configured to cause a movement of the at least one link; and at least one communication apparatus located on at least one of the drive or the movable arm, the at least one communication apparatus comprising a first optical data link comprising a first transmitter and a first receiver, the first optical data link being rotatable about an optical link axis coincident with the axis, the first transmitter being configured to transmit a first optical beam in a conical cross section shape that expands from the first transmitter; and a second optical data link comprising a second transmitter and a second receiver, the second optical data link being rotatable about the optical link axis, the second transmitter being configured to transmit a second optical beam in a conical cross section shape that expands from the second transmitter. At least one of the first transmitter or the second transmitter are adjustably positioned about the optical link axis to minimize at least one of a first alignment angle or a second alignment angle between the respective optical beam and the optical link axis. At least one of the first transmitter or the second transmitter is configured to provide an optical communication link between the first optical data link and the second optical data link to control a positioning of the movable arm.

The apparatus may further comprise a controller configured to control operations of at least one of the first transmitter or the second transmitter, the controller comprising at least one processor and at least one memory storing instructions that, when executed with the at least one processor, cause the at least one communication apparatus to transmit optical data in the first optical beam from the first transmitter in the first optical data link to the second receiver in the second optical link. A first transmission from the first transmitter to the second receiver may be parallel to a second transmission from the second transmitter to the first receiver, the first transmission and the second transmission may be parallel to and offset from the axis, a first trace of the first transmission at the first receiver may be circular, and a second trace of the second transmission at the second receiver may be circular. The first transmitter may be angled relative to the second receiver such that a first transmission from the first transmitter is received at the second receiver in a first elliptical trace and offset from a center of the first elliptical trace, and the second transmitter may be angled relative to the first receiver such that a second transmission from the second transmitter is received at the first receiver in a second elliptical trace and offset from a center of the second elliptical trace. The first receiver may be coaxially aligned with the second receiver along the axis, a first transmission from the first transmitter to the second receiver may be parallel to a second transmission from the second transmitter to the first receiver, and the first transmission and the second transmission may be parallel to and offset from the axis. The first receiver may be coaxially aligned with the second receiver along the axis, the first transmitter may be angled relative to the second receiver such that a first transmission from the first transmitter is received at the second receiver in a first elliptical trace with the second receiver substantially at a center of the first elliptical trace, and the second transmitter may be angled relative to the first receiver such that a second transmission from the second transmitter is received at the first receiver in a second elliptical trace with the first receiver substantially at a center of the second elliptical trace.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances.

What is claimed is:

1. An apparatus, comprising:
a first data link positioned proximate a first end of an axis and rotatable about the axis, the first data link comprising,
a first transmitter, and
a first receiver; and
a second data link positioned proximate a second end of the axis and rotatable about the axis, the second data link comprising,
a second transmitter, and
a second receiver;
wherein the first transmitter is configured to send data using a first optical beam that expands in cross sectional shape to the second receiver, and wherein the second transmitter is configured to send data using a second optical beam that expands in cross sectional shape to the first receiver; and
wherein at least one of the first transmitter or the second receiver are adjustably positioned about the axis to minimize a first alignment angle between the first optical beam and the axis, and wherein at least one of the second transmitter or the first receiver are adjustably positioned about the axis to minimize a second alignment angle between the second optical beam and the axis.

2. The apparatus of claim 1, further comprising at least one first shaping element positioned at the first transmitter and at least one second shaping element positioned at the second receiver, the at least one first shaping element and the at least one second shaping element being configured to physically shape the first optical beam.

3. The apparatus of claim 2, further comprising at least one third shaping element positioned at the second transmitter and at least one fourth shaping element positioned at the first receiver, the at least one third shaping element and the at least one fourth shaping element being configured to physically shape the second optical beam.

4. The apparatus of claim 1, wherein the first optical beam and the second optical beam define an area between the first data link and the second data link in which the first optical beam and the second optical beam are modulated.

5. The apparatus of claim 1, further comprising a first barrier window and a second barrier window, the first barrier window and the second barrier window being positioned between the first data link and the second data link.

6. The apparatus of claim 1, wherein a first transmission from the first transmitter to the second receiver is parallel to a second transmission from the second transmitter to the first receiver, wherein the first transmission and the second transmission are parallel to and offset from the axis, wherein the first transmission is received at the second receiver in a first circular trace, and wherein the second transmission is received at the first receiver in a second circular trace.

7. The apparatus of claim 1, wherein the first transmitter is angled relative to the second receiver such that a first transmission from the first transmitter is received at the second receiver in a first elliptical trace and offset from a center of the first elliptical trace, and wherein the second transmitter is angled relative to the first receiver such that a second transmission from the second transmitter is received at the first receiver in a second elliptical trace and offset from a center of the second elliptical trace.

8. The apparatus of claim 1, wherein the first receiver is coaxially aligned with the second receiver along the axis, wherein a first transmission from the first transmitter to the second receiver is parallel to a second transmission from the second transmitter to the first receiver, and wherein the first transmission and the second transmission are parallel to and offset from the axis.

9. The apparatus of claim 1, wherein the first receiver is coaxially aligned with the second receiver along the axis, wherein the first transmitter is angled relative to the second receiver such that a first transmission from the first transmitter is received at the second receiver in a first elliptical trace with the second receiver substantially at a center of the first elliptical trace, and wherein the second transmitter is angled relative to the first receiver such that a second transmission from the second transmitter is received at the first receiver in a second elliptical trace with the first receiver substantially at a center of the second elliptical trace.

10. A communication apparatus for optical communication, the communication apparatus comprising:
a first optical data link comprising a first transmitter and a first receiver, the first optical data link being rotatable about an axis extending longitudinally through the communication apparatus, the first transmitter being configured to transmit a first optical beam in a conical cross section shape that expands from the first transmitter; and
a second optical data link comprising a second transmitter and a second receiver, the second optical data link being rotatable about the axis, the second transmitter being configured to transmit a second optical beam in a conical cross section shape that expands from the second transmitter;
wherein at least one of the first transmitter or the second transmitter are adjustably positioned about the axis to minimize at least one of a first alignment angle or a second alignment angle between the respective optical beam and the axis.

11. The communication apparatus of claim 10, wherein the first transmitter is configured to transmit the first optical beam to the second receiver, and wherein the second transmitter is configured to transmit the second optical beam to the first receiver.

12. The communication apparatus of claim 10, wherein an area between the first optical data link and the second optical data link comprises an active area in which the first optical beam and the second optical beam are modulated.

13. The communication apparatus of claim 10, wherein the communication apparatus further comprises a first barrier window and a second barrier window positioned between the first optical data link and the second optical data link.

14. The communication apparatus of claim 10, further comprising a first transmitting lens on the first transmitter, a first receiving lens on the first receiver, a second transmitting lens on the second transmitter, and a second receiving lens on the second receiver, wherein at least one of the first transmitting lens, the second transmitting lens, the first receiving lens, or the second receiving lens is a plano-convex lens or a flat transmissive glass.

15. The communication apparatus of claim 10, further comprising a controller configured to control operations of at least one of the first optical data link or the second optical data link, the controller comprising at least at least one processor and at least one memory storing instructions that, when executed with the at least one processor, cause the communication apparatus to perform operations.

16. The communication apparatus of claim 10, further comprising at least one mechanism configured to allow for movement of at least one of the first transmitter, the second transmitter, the first receiver, or the second receiver.

17. The communication apparatus of claim 10, wherein a first transmission from the first transmitter to the second receiver is parallel to a second transmission from the second transmitter to the first receiver, wherein the first transmission and the second transmission are parallel to and offset from the axis, wherein a first trace of the first transmission at the second receiver is circular, and wherein a second trace of the second transmission to the first receiver is circular.

18. The communication apparatus of claim 10, wherein the first transmitter is angled relative to the second receiver such that a first transmission from the first transmitter is received at the second receiver in a first elliptical trace and offset from a center of the first elliptical trace, and wherein the second transmitter is angled relative to the first receiver such that a second transmission from the second transmitter is received at the first receiver in a second elliptical trace and offset from a center of the second elliptical trace.

19. The communication apparatus of claim 10, wherein the first receiver is coaxially aligned with the second receiver along the axis, wherein a first transmission from the first transmitter to the second receiver is parallel to a second transmission from the second transmitter to the first receiver, and wherein the first transmission and the second transmission are parallel to and offset from the axis.

20. The communication apparatus of claim 10, wherein the first receiver is coaxially aligned with the second receiver along the axis, wherein the first transmitter is angled relative to the second receiver such that a first transmission from the first transmitter is received at the second receiver in a first elliptical trace with the second receiver substantially at a center of the first elliptical trace, and wherein the second transmitter is angled relative to the first receiver such that a second transmission from the second transmitter is received at the first receiver in a second elliptical trace with the first receiver substantially at a center of the second elliptical trace.

21. A method, comprising:
placing a first receiver of a first optical data link in line with an axis of rotation of the first optical data link;
placing a second receiver of a second optical data link in line with the axis of rotation of the first optical data link and spaced from the first optical data link;
placing a first transmitter proximate to the first receiver;
placing a second transmitter proximate to the second receiver;
adjusting a distance between the first optical data link and the second optical data link; and
transmitting a first optical beam from the first transmitter in a conical cross sectional shape to the second receiver and transmitting a second optical beam from the second transmitter in a conical cross sectional shape to the first receiver.

22. The method of claim 21, further comprising adjusting a position of the second transmitter to adjust a first alignment angle between the second transmitter and the first receiver and adjusting a position of the first transmitter to adjust a second alignment angle between the first transmitter and the second receiver, the adjusting of the alignment angles being to adjust an optical communication between the first optical data link and the second optical data link.

23. An apparatus, comprising:
a drive;
a movable arm connected to the drive, the movable arm comprising, at least one link connected at a first end thereof to the drive and rotatable about an axis extending from the drive and through the first end of the link, and
at least one actuator located in the drive and configured to cause a movement of the at least one link; and
at least one communication apparatus located on at least one of the drive or the movable arm, the at least one communication apparatus comprising,
a first optical data link comprising a first transmitter and a first receiver, the first optical data link being rotatable about an optical link axis coincident with the axis, the first transmitter being configured to transmit a first optical beam in a conical cross section shape that expands from the first transmitter; and
a second optical data link comprising a second transmitter and a second receiver, the second optical data link being rotatable about the optical link axis, the second transmitter being configured to transmit a second optical beam in a conical cross section shape that expands from the second transmitter;
wherein at least one of the first transmitter or the second transmitter are adjustably positioned about the optical link axis to minimize at least one of a first alignment angle or a second alignment angle between the respective optical beam and the optical link axis; and
wherein at least one of the first transmitter or the second transmitter is configured to provide an optical communication link between the first optical data link and the second optical data link to control a positioning of the movable arm.

24. The apparatus of claim 23, further comprising a controller configured to control operations of at least one of the first transmitter or the second transmitter, the controller comprising at least one processor and at least one memory storing instructions that, when executed with the at least one processor, cause the at least one communication apparatus to transmit optical data in the first optical beam from the first transmitter in the first optical data link to the second receiver in the second optical link.

25. The apparatus of claim 23, wherein a first transmission from the first transmitter to the second receiver is parallel to a second transmission from the second transmitter to the first receiver, wherein the first transmission and the second transmission are parallel to and offset from the axis, wherein a first trace of the first transmission at the first receiver is circular, and wherein a second trace of the second transmission at the second receiver is circular.

26. The apparatus of claim 23, wherein the first transmitter is angled relative to the second receiver such that a first transmission from the first transmitter is received at the second receiver in a first elliptical trace and offset from a center of the first elliptical trace, and wherein the second transmitter is angled relative to the first receiver such that a second transmission from the second transmitter is received at the first receiver in a second elliptical trace and offset from a center of the second elliptical trace.

27. The apparatus of claim 23, wherein the first receiver is coaxially aligned with the second receiver along the axis, wherein a first transmission from the first transmitter to the second receiver is parallel to a second transmission from the second transmitter to the first receiver, and wherein the first transmission and the second transmission are parallel to and offset from the axis.

28. The apparatus of claim 23, wherein the first receiver is coaxially aligned with the second receiver along the axis, wherein the first transmitter is angled relative to the second receiver such that a first transmission from the first transmitter is received at the second receiver in a first elliptical trace with the second receiver substantially at a center of the first elliptical trace, and wherein the second transmitter is angled relative to the first receiver such that a second transmission from the second transmitter is received at the first receiver in a second elliptical trace with the first receiver substantially at a center of the second elliptical trace.
